(19) United States
(12) Patent Application Publication
(10) Pub. No.: US 2025/0204528 A1
(43) Pub. Date: Jun. 26, 2025

(54) USE OF 2-AMINO-3-INDOLYL BUTYRIC ACID OR 3-METHYLPYRROLIDINE-2-CARBOXYLIC ACID AS PLANT IMMUNITY ELICITOR

(71) Applicant: NANJING TIANNONG BIOTECHNOLOGY CO., LTD, Nanjing, Jiangsu (CN)

(72) Inventors: Shiguo CHEN, Nanjing (CN); He WANG, Nanjing (CN); Jingjing LI, Nanjing (CN); Liru MI, Nanjing (CN); Yu Jl, Nanjing (CN); Aiping GUO, Nanjing (CN)

(73) Assignee: NANJING TIANNONG BIOTECHNOLOGY CO., LTD, Nanjing, Jiangsu (CN)

(21) Appl. No.: 18/717,021

(22) PCT Filed: Dec. 5, 2022
(86) PCT No.: PCT/CN2022/136464

§ 371 Date: Jun. 6, 2024

(30) Foreign Application Priority Data
Dec. 6, 2021 (CN) 202111511596.8

(51) Int. Cl. A01N 43/36; A01N 43/38; A01P 21/00

(52) U.S. Cl. CPC A01N 43/36; A01N 43/38; A01P 21/00

(57) ABSTRACT

A 2-amino-3-indolyl butyric acid or 3-methylpyrrolidine-2-carboxylic acid in the preparation of a plant immunity elicitor. 2-amino-3-indolyl butyric acid or 3-methylpyrrolidine-2-carboxylic acid as a natural active substance is developed into a plant immunity elicitor. The plant immunity elicitor can be used for improving the resistance of plants to a biotic stress and an abiotic stress, effectively preventing fungi, bacteria and viruses from infecting the plants, and further reducing the pathogenicity. Meanwhile, the plant immunity elicitor can significantly improve resistant ability of the plants to high temperature, low temperature, drought and salt stresses. 2-amino-3-indolyl butyric acid or 3-methylpyrrolidine-2-carboxylic acid has the characteristics of safety, environmental protection and high efficiency.

### TECHNICAL FIELD

The present invention belongs to the field of agricultural biopesticides and relates to use 2-amino-3-indolyl butyric acid or 3-methylpyrrolidine-2-carboxylic acid as a plant immunity elicitor.

### BACKGROUND

In agricultural production, losses due to abiotic stresses such as high temperature, low temperature, drought and salt are very large. In recent years, extreme weather frequently appears in the world and the stress faced by agricultural plants is also becoming more severe. High temperature and low temperature seriously affect the growth and development of plants, and further affect the yield and quality of the plants. Drought is one of the most important adversity stress factors influencing plant survival, growth and distribution. The area of global arid and semiarid regions accounts for 40% or more of the total cultivated area currently. In recent years, due to global climate deterioration, the generation period of drought is shorter, the degree of drought is heavier, and the threat to grain production is larger. Besides, soil alkalization is a main abiotic limiting factor which hinders the growth and the productivity of crops all over the world, and has a great harmful effect on biospheres and ecological structures. The area of the Chinese saline-alkali soil is the third in the world and accounts for about 10% of the area of the world saline-alkali soil. Therefore, aiming at the main abiotic stress condition faced by different crops in the current practical production, the development of products and technologies aiming at reducing the harm level of the plants is urgent for ensuring the agricultural safety production.

In addition to the abiotic stresses, the plants are increasingly threatened by various plant diseases and insect pests during the growth and development processes. Once a plurality of diseases occur in the agricultural production, large-area serious yield reduction and even no harvest of crops are often caused. Therefore, prevention of plant diseases and insect pests in agriculture is especially important. At present, the strategy of directly killing pathogenic microorganisms by applying pesticides is mainly used for preventing and treating plant diseases. However, the long-term and large-scale application of microbicides and an applying method not scientific enough bring a series of problems of overproof pesticide residue of agricultural products, pesticide hazard to crops, resistance of pathogenic microorganisms, environmental pollution, reduction of biological diversity and the like, also enable the traditional killing strategy for plant protection to face the risk of failure, and seriously threaten the sustainable development of agriculture and the safety of grain production. Therefore, the development of an environment-friendly, efficient and economic plant immunizing agent can reduce or inhibit the morbidity level of crops by enhancing the self-resistance of plants before disease onset or in the early stage of diseases of the crops, thereby realizing the aim of using less or no chemical microbicide, which has a very important significance for realizing agricultural green production.

Plant immunity elicitors are a new class of conceptual pesticides that enhance disease resistance and stress resistance of the plants by activating the immune system of the plants and regulating the metabolism of the plants. The plant immunity elicitors have no direct microbicidel activity, and mainly prevent and control diseases by promoting the plants to use an own natural immune system without depending on an exogenous pesticide to directly kill pathogens. Therefore, pathogenic microorganisms are not easy to generate drug resistance and the plant immunity elicitor accord with the idea of realizing green prevention and control under the condition of effectively protecting agricultural biological diversity. In addition, in nature, the growth of the plants is generally not only subjected to a single stress, but also to a combination of stresses, such as drought and high temperature stress, which often occurring simultaneously, causing more serious damage to the plants. Although the plants have immune systems, the capability of resisting adversity stress is limited. The stress resistance level of the plants can be increased by using the plant immunity elicitors. Therefore, the plant immunity elicitors are used as a new pesticide, provide a new development idea for agricultural sustainable development and effective green prevention and control of diseases, and are a main direction for future development of green plant protection.

2-amino-3-indolyl butyric acid with the molecular formula of C₁₂H₁₄N₂O₂ and the molecular weight of 218 g/mol is light brown crystal. The chemical synthesis method of the compound is multiple, but the process is relatively complicated (Han et al., 2001; Liu et al., 2012). Studies showed that 2-amino-3-indolyl butyric acid is an intermediate in the biosynthetic pathway of some natural products such as maremycin and streptonigrin having an anticancer activity (Zou et al., 2013; Kong et al., 2016). The first step in the synthesis of streptonigrin by Streptomyces flocculus may be the synthesis of 2-amino-3-indolyl butyric acid (Gould&Chaug, 1977). Hartley et al. used a S. flucculus enzyme to perform an in-vitro enzyme catalysis test. It was found that a methyl group of S-adenosylmethionine can be transferred to tryptophan to synthesize 2-amino-3-indolyl butyric acid (Hartley&Speedie, 1984). In addition, scientists have modified a tryptophan synthase subunit of Pyrococcus furiosus, a Hyperthermophilic archaea. The enzyme can directly react with indole to synthesize 2-amino-3-indolyl butyric acid by using threonine (Herger et al., 2016; Boville et al., 2018). So far, since 2-amino-3-indolyl butyric acid has been an intermediate in the synthesis of several natural antiviral and antitumor products, the studies are mainly focused on chemical synthetic methods, in-vitro enzymatic catalysis and biosynthetic pathways. The study of biosynthesis is only limited to the prokaryote Streptomyces flocculus. The existence of the compound in a wide range of eukaryotes and the biological activity thereof have not been reported so far.

3-methylpyrrolidine-2-carboxylic acid with the molecular formula of C₆H₁₁NO₂ and the molecular weight of 129 g/mol is a colorless crystal. The first report on the compound was in 1964 that 3-methylpyrrolidine-2-carboxylic acid was first obtained by chemical synthesis. Subsequent activity studies found that the compound can inhibit the synthesis of actinomycin in Streptomyces antibioticus (Yoshida et al., 1964; Mauger et al., 1966; Katz et al., 1968; Yoshida et al., 1968). A study on the cyclic heptapeptide paraherquamide A from Penicillium sp. found that its structure contains a β-methyl-β-hydroxyproline component (Stocking et al., 2001). In 2003, Tan et al. isolated two novel cyclic heptapeptides scytalidamides A and B from a fermentation broth of a marine fungus Scytalidium. Sp. It was found that 3-methylpyrrolidine-2-carboxylic acid can be obtained by hydrolyzing scytalidamides B (Tan et al., 2003). Fredenhagen et al. hydrolyzed various polypeptides neoefrapeptins A-N synthesized by Geotrichum candidum and found that 4 of the polypeptides contained the structure of 3-methylpyrrolidine-2-carboxylic acid (Fredenhagen et al., 2006). Until now, the studies on 3-methylpyrrolidine-2-carboxylic acid has been mostly focused on the hydrolysis and biosynthesis pathways of the polypeptides. There are no report about the free existence of the polypeptides and studies on the biological activity and the like are blank.

### SUMMARY

Aiming at the shortcomings of the prior art, the present invention provides use of 2-amino-3-indolyl butyric acid or 3-methylpyrrolidine-2-carboxylic acid in the preparation of a plant immunity elicitor.

Another objective of the present invention is to provide an immunity elicitor.

Yet another objective of the present invention is to provide a method for improving resistance of a plant to a biotic and/or an abiotic stress. The objectives of the present invention can be realized by the following technical solutions:

2-amino-3-indolyl butyric acid and 3-methylpyrrolidine-2-carboxylic acid are natural products isolated from Alternaria alternata.

2-amino-3-indolyl butyric acid has the following structural formula:

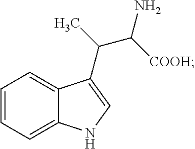 [SMILES: CC(c1c[nH]c2ccccc12)C(N)C(=O)O]

and

3-methylpyrrolidine-2-carboxylic acid has the following structural formula:

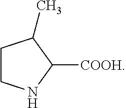

Use of 2-amino-3-indolyl butyric acid and/or 3-methylpyrrolidine-2-carboxylic acid in the preparation of a plant immunity elicitor is provided.

Use of 2-amino-3-indolyl butyric acid and/or 3-methylpyrrolidine-2-carboxylic acid in improving resistance of a plant to an abiotic stress and/or a biotic stress is provided.

Use of 2-amino-3-indolyl butyric acid and/or 3-methylpyrrolidine-2-carboxylic acid in improving resistance of a plant to high temperature, low temperature, drought and/or salt stresses is provided.

Use of 2-amino-3-indolyl butyric acid and/or 3-methylpyrrolidine-2-carboxylic acid in improving resistance of a plant to fungal, bacterial and viral stresses is provided.

Use of 2-amino-3-indolyl butyric acid and/or 3-methylpyrrolidine-2-carboxylic acid in preventing and treating a fungal disease, a bacterial disease and a viral disease is provided.

The fungal disease is wheat powdery mildew, the bacterial disease is a disease caused by Pseudomonas syringae and the viral disease is tomato spotted wilt.

The plant is selected from a grain crop, an economic crop and a vegetable. The grain crop is preferably wheat, the economic crop is preferably tea leaves and cotton, and the vegetable is preferably tomatoes.

A plant immunity elicitor contains any one or two of 2-amino-3-indolyl butyric acid or 3-methylpyrrolidine-2-carboxylic acid.

As a preference of the present invention, the plant immunity elicitor containing a component A: any one or two of 2-amino-3-indolyl butyric acid 1 or 3-methylpyrrolidine-2-carboxylic acid, and a component B: a surfactant. As a further preference of the present invention, the surfactant is Tween 20 and the concentration of Tween 20 in the plant immunity elicitor is preferably 0.02% (v/v).

As a further preference of the present invention, the concentration of 2-amino-3-indolyl butyric acid or 3-methylpyrrolidine-2-carboxylic acid in the plant immunity elicitor is 0.1-10,000 nm.

Existing relevant studies on 2-amino-3-indolyl butyric acid and 3-methylpyrrolidine-2-carboxylic acid have not been reported in the field of natural microbial metabolites and biopesticides. The plant immunity elicitor belongs to a novel pesticide and is a main development direction of green prevention and control in the field of future plant protection. The development of the plant immunity elicitors is in an initial stage in China and the formally registered products are few. Therefore, the development of natural plant immunity elicitors and the promotion of industrialization thereof are of great significance for guaranteeing the safety of agricultural production and improving the competitiveness of agricultural products. 2-amino-3-indolyl butyric acid and 3-methylpyrrolidine-2-carboxylic acid have good performances in related induced immunity stress resistance experiments, and can improve resistance of plants to biotic stresses and abiotic stresses.

A method for preventing and treating diseases by using a natural metabolite 2-amino-3-indolyl butyric acid or 3-methylpyrrolidine-2-carboxylic acid isolated from saprophytic fungus Alternaria alternata is as follows in detail: in the concentration range of 0.1-10,000 nm (adding 0.02% by volume of Tween 20 as a surfactant), the natural metabolite can effectively inhibit infection and diffusion of viruses, bacteria and fungi on plants, inhibit generation and spread of diseases, and improve the resistance of the plants to high temperature, low temperature, drought and salt stresses.

A method for improving resistance of a plant to a biotic stress comprises applying the plant immunity elicitor to the plant in advance; and the biotic stress is selected from any one or more of fungal, bacterial and viral stresses.

In a method for preventing and treating tomato spotted wilt, at the concentration of 0.1-10 nm (0.02% by volume of a surfactant Tween 20 is added), the 2-amino-3-indolyl butyric acid or 3-methylpyrrolidine-2-carboxylic acid can significantly inhibit the diffusion of viruses 3 days after tobacco is inoculated with the tomato spotted wilt viruses (TSWVs). After 15 days, the disease condition of the tobacco is investigated and disease indexes of tobacco plants treated by 2-amino-3-indolyl butyric acid and 3-methylpyrrolidine-2-carboxylic acid are both significantly reduced. At the low concentration of 10 nm, 2-amino-3-indolyl butyric acid can inhibit the expression of the TSWVs on tobacco leaves effectively. The disease index, relative immune effect and virus content are 30.42%, 67.36% and 0.17 respectively. At the low concentration of 10 nm, 3-methylpyrrolidine-2-carboxylic acid can also effectively inhibit the expression of the TSWVs on the tobacco leaves. The disease index, relative immune effect and virus content are 21.44%, 75.73% and 0.16 respectively.

In a method for preventing and treating a bacterial disease by 2-amino-3-indolyl butyric acid and 3-methylpyrrolidine-2-carboxylic acid, in the concentration range of 100-10,000 nm (0.02% by volume of a surfactant Tween 20 is added), with the increase of the treatment concentration, the accumulation amount of bacterial PstDC3000 in Arabidopsis thaliana leaves is gradually reduced. When the treatment concentration of 2-amino-3-indolyl butyric acid is 10,000 nm, the number of bacteria in each milligram of the leaves is 4.79×10⁵, which is reduced by 85.039% compared with a blank control, and the disease index is 29.58. When the treatment concentration of 3-methylpyrrolidine-2-carboxylic acid is 10,000 nm, the number of bacteria in each milligram of the leaves is 1.64×10⁵, which is reduced by 94.92% compared with the blank control, and the disease index is 23.26. The result shows that 2-amino-3-indolyl butyric acid and 3-methylpyrrolidine-2-carboxylic acid can stimulate the autoimmunity of the Arabidopsis thaliana, inhibit the propagation of the bacteria in the plants, reduce the accumulation of the bacteria, and delay and inhibit the development of diseases.

A method for preventing and treating wheat powdery mildew by using 2-amino-3-indolyl butyric acid or 3-methylpyrrolidine-2-carboxylic acid, at the concentration

range of 100-10,000 nm (0.02% by volume of a surfactant Tween 20 is added), an investigate is performed after 10 days of wheat inoculation with powdery mildew fungi. It is found that with the increase of the treatment concentration, the disease index of the wheat powdery mildew is reduced and the relative immune effect is improved. When 2-amino-3-indolyl butyric acid is used for treatment at the high concentration of 10,000 nm, the disease index is 29.70 and the relative immune effect is 68.42%. When 3-methylpyrrolidine-2-carboxylic acid is used for treatment at the high concentration of 10,000 nm, the disease index is 30.26 and the relative immune effect is 68.57%.

In a method for preventing wheat powdery mildew in a field by using 2-amino-3-indolyl butyric acid, at the treatment concentration of 1,000 nm, the disease index, relative immune effect and thousand-grain weight of wheat are 45.44, 40.55% and 27.39 g respectively, which are obviously better than those of an ATaiLing (a plant immunity elicitor) treatment group and an auxiliary agent control group. In conclusion, 2-amino-3-indolyl butyric acid has a significant inhibition effect on the occurrence and diffusion of the wheat powdery mildew.

A method for improving resistance of a plant to an abiotic stress comprises applying the plant immunity elicitor of the present invention to a plant; and the abiotic stress is selected from any one or more of high temperature, low temperature, drought and/or salt stresses.

In a method for improving high-temperature resistance of a plant by using 2-amino-3-indolyl butyric acid or 3-methylpyrrolidine-2-carboxylic acid, a 2-amino-3-indolyl butyric acid solution (0.02% by volume of a surfactant Tween 20 is added) at the concentration of 1-1,000 nm is used to treat and induce a ryegrass seedling and Arabidopsis thaliana. It is found that after the plant in a treatment group is subjected to a high-temperature treatment at 45° C. for 12 h and recovered at room temperature for 7 d, the photosynthetic performance index PI_{ABS} is higher than that of a control group, and the heat damage index is lower than that of the control group. The result demonstrates that the damage level of high temperature to the seedling is effectively relieved by exogenously spraying the 2-amino-3-indolyl butyric acid or 3-methylpyrrolidine-2-carboxylic acid solution.

In a method for improving low-temperature resistance of a plant by using 2-amino-3-indolyl butyric acid or 3-methylpyrrolidine-2-carboxylic acid, a 2-amino-3-indolyl butyric acid or 3-methylpyrrolidine-2-carboxylic acid solution (0.02% by volume of a surfactant Tween 20 is added) at the concentration of 1-1,000 nM is used to perform a leaf surface spraying treatment on a tea leaf seedling. It is found that after 24 h of a low temperature stress at −4° C., the photosynthetic performance index PI_{ABS} of the tea seedling treated by 1 nM, 10 nM, 100 nM and 1,000 nM of the solution is obviously higher than that of a control group, and the cold damage index is obviously lower than that of the control group, indicating that 2-amino-3-indolyl butyric acid and 3-methylpyrrolidine-2-carboxylic acid both can effectively relieve damage of the tea seedling by low temperature, and improve resistance of tea leaves to the low temperature stress.

In a method for improving resistance of a plant to a drought stress by using 2-amino-3-indolyl butyric acid or 3-methylpyrrolidine-2-carboxylic acid, 100 nM and 1,000 nM of 2-amino-3-indolyl butyric acid or 3-methylpyrrolidine-2-carboxylic acid solutions (0.02% by volume of a surfactant Tween 20 is added) are used to perform a leaf surface spraying treatment on hydroponic wheat with two true leaves and one terminal bud. It is found that under a stress of 25% polyethylene glycol-6000 (PEG-6000), each biomass of the wheat treated by 100 nM and 1,000 nM of the solutions is significantly higher than that of a control group, indicating that 2-amino-3-indolyl butyric acid or 3-methylpyrrolidine-2-carboxylic acid improves the resistance of the wheat to the drought stress.

In a method for improving resistance of a plant to a salt stress by using 2-amino-3-indolyl butyric acid or 3-methylpyrrolidine-2-carboxylic acid, a 2-amino-3-indolyl butyric acid or 3-methylpyrrolidine-2-carboxylic acid solution (0.02% by volume of a surfactant Tween 20 is added) at the concentration of 1-1,000 nM is used to perform a leaf surface spraying treatment on hydroponic cotton at a stage of two true leaves. It is found that under a stress of 100 nM of NaCl, the mortality and salt damage index of the cotton in treatment groups respectively sprayed with 2-amino-3-indolyl butyric acid or 3-methylpyrrolidine-2-carboxylic acid are lower than those of a control group, indicating that 2-amino-3-indolyl butyric acid and 3-methylpyrrolidine-2-carboxylic acid improve a resistance level of the cotton to salt.

### Beneficial Effects

The present invention has the following main advantages and positive effects:

2-amino-3-indolyl butyric acid and 3-methylpyrrolidine-2-carboxylic acid are both natural products, and have simple structures and a simple and convenient biological extraction method. The present invention confirms that 2-amino-3-indolyl butyric acid and 3-methylpyrrolidine-2-carboxylic acid can induce plants to generate immunological activity on a part of diseases seriously harmful in agricultural production and induce the plants to generate stress resistance on more prominent abiotic stresses in the current agricultural production, and thus have the potential of being developed into a natural plant immunity elicitor.

The present invention discovers that 2-amino-3-indolyl butyric acid and 3-methylpyrrolidine-2-carboxylic acid have higher broad-spectrum immunity induction activities, can induce tobacco to generate immunoreaction at the low concentration of 0.1 nM so as to prevent the generation and spread of tomato spotted wilt, can inhibit accumulation of Pseudomonas syringae PstDC3000 in Arabidopsis thaliana leaves and reduce the disease index of Arabidopsis thaliana at the concentration of 100 nM, and can induce wheat to produce a relative immune effect of 53.58% against powdery mildew at the concentration of 1,000 nM. In the aspect of coping with abiotic stresses, the 2-amino-3-indolyl butyric acid and 3-methylpyrrolidine-2-carboxylic acid can improve resistance of ryegrass and Arabidopsis thaliana to high temperature and resistance of wheat to drought and tea leaves to low temperature at the concentration of 1-1,000 nM, and can significantly improve resistance of cotton to salting at the concentration of 100 nM. 2-amino-3-indolyl butyric acid and 3-methylpyrrolidine-2-carboxylic acid have low consumption and no pollution to the environment, and are efficient and environment-friendly biopesticides, indicating the huge utilization value and wide application prospect in agricultural production.

The present invention can be used for controlling main fungal diseases occurring in farmlands, such as wheat powdery mildew, viral diseases such as tomato spotted wilt, and bacterial diseases, such as diseases caused by Pseudomonas syringae. This indicates that the compounds can induce plants to generate immune response to various diseases. Meanwhile, the compounds can induce the plants to resist various abiotic stresses in the nature, such as high temperature, low temperature, drought and salt stresses, thereby providing a technical reference for relieving the damage of the various stresses to the plants.

The present invention discovers that a stem and leaf treatment by 2-amino-3-indolyl butyric acid or 3-methylpyrrolidine-2-carboxylic acid can prevent the occurrence and spread of main diseases in various agricultural productions, and can relieve the inhibition of various abiotic stresses suffered by crops in the growth and development process. 2-amino-3-indolyl butyric acid and 3-methylpyrrolidine-2-carboxylic acid are convenient to use, can play a role in preventing in advance, reduce the damage level of the plants caused by various biotic and abiotic stresses, reduce the use amount of pesticides, and save the production cost. In addition, 2-amino-3-indolyl butyric acid and 3-methylpyrrolidine-2-carboxylic acid are naturally-occurring metabolites with simple structures, belong to α-amino acids, have very high environmental and biological safety, and are green and efficient biopesticides.

### DETAILED DESCRIPTION

The inventor separates and purifies saprophytic fungus Alternaria alternata to obtain 2-amino-3-indolyl butyric acid and 3-methylpyrrolidine-2-carboxylic acid, and identifies the structures thereof. Then the substances are subjected to studies on the biological activity, application range and crop safety. It is found that the substances are natural plant immunity elicitor and have the potential of being developed into biopesticides. Meanwhile, the research idea provides a new development direction for the development of biopesticides, the prevention and treatment of diseases, and the alleviation of abiotic stresses. The essential features of the present invention can be seen in the following embodiments and examples, which should not be construed as limiting the present invention in any way.

### Example 1 (Biosynthesis, Extraction Method and Structural Identification of Compounds of the Present Invention)

(1) Culture of Alternaria alternata

Glucose sodium nitrate medium: glucose, 40.0 g; NaNO₃, 1.0 g; NH₄Cl, 0.25 g; KH₂PO₄, 1.0 g; KCl, 0.25 g; NaCl, 0.25 g; MgSO₄·7H₂O, 0.5 g; FeSO₄·7H₂O, 0.01 g; ZnSO₄·7H₂O, 0.01 g; and yeast extract: 1 g and water added to a constant volume of 1 L and pH adjusted to 5.5.

A culture method of Alternaria alternata included the following steps: a stored strain was activated by using a PDA culture medium, colonies with consistent growth were selected after 7 d and beat to fungus cakes with the diameter of 5 mm, and the fungus cakes were inoculated into 500 mL of the culture medium at the inoculation amount of one fungus cake per 100 mL. The culture medium inoculated with the fungus blocks was placed into a constant-temperature shaking table to be cultured at 140 rpm and 25° C. in the dark place for 7 d.

### (2) Extraction of Compounds

Mycelia were isolated from the fermentation broth after 7 d of the culture. The fermentation broth was separated by using a centrifuge at 10,000 rpm for 5 min. The supernatant was removed. The mycelia were removed from the bottom of a flask and placed in a mortar, and rapidly ground to a uniform powder with liquid nitrogen. The powder was put into a centrifuge tube, 5 mL of water was added, and the mixture was shaken evenly and stood for extraction for 1 h. The precipitate was removed by centrifugation at 10,000 rpm for 5 min. The obtained supernatant was an amino acid crude extract.

(3) Separation and Purification of 2-amino-3-indolyl butyric Acid by HPLC Method

The compound crude extract was separated and purified by using high performance liquid chromatography, and eluted by using a double-mobile-phase method. Elution conditions were A: 60% water (containing 0.1% formic acid), B: 40% acetonitrile, ultraviolet detection wavelength of 256 nm, and the flow rate of 2 mL·min⁻¹. The impurities in the crude extract can be removed by separation to obtain a single component, 2-amino-3-indolyl butyric acid, and the time of peaking was 9.6 min. The method can separate the compound in the Alternaria alternata effectively.

The structure of a light brown crystal obtained by the separation was identified by means of a nuclear magnetic resonance (NMR) and a mass spectrometry.

An NMR result was as follows: ¹H NMR (500 MHZ, Deuterium Oxide) δ 7.67-7.56 (m, 1H, Ph), 7.23-7.16 (d, J=10 Hz, 1H, NHCH), 7.19-7.12 (m, 1H, Ph), 7.11-7.00 (m, 1H, Ph), 4.18-4.01 (dd, J₁=5 Hz, J₂=5 Hz, 1H, CH—NH₂), 3.89-3.69 (m, 1H, CHCH₃), 1.42-1.28 (d, J₁=10 Hz, J₂=5 Hz, 3H, CHCH₃).

¹³C NMR (125 MHZ, Deuterium Oxide) δ 173.24 (CHCOOH), 136.61 (Ph), 129.53 (Ph), 123.94 (NHCH), 122.38 (Ph), 119.54 (Ph), 118.47 (Ph), 113.16 (Ph), 112.08 (CHNH), 62.55 (CHNH₂), 31.31 (CHCH₃), 13.11 (CHCH₃).

The mass spectrometry showed that the molecular ion peak of the compound was 219.1028 [M+H]+ and the molecular formula thereof was determined as C₁₂H₁₄N₂O₂. The result by combining HNMR and CNMR confirmed that the compound was 2-amino-3-indolyl butyric acid.

### (4) Separation and Purification by HPLC Method

The amino acid crude extract was separated and purified by using the high performance liquid chromatography, and eluted by using the double-mobile-phase method. Elution conditions were A: 60% water (containing 0.1% formic acid), B: 40% acetonitrile, ultraviolet detection wavelength of 256 nm, and the flow rate of 2 mL·min⁻¹. The impurities in the crude extract can be removed by separation to obtain a single component, 3-methylpyrrolidine-2-carboxylic acid, and the time of peaking was 5.9 min. The method can separate the compound in the Alternaria alternata effectively.

The structure of 3-methylpyrrolidine-2-carboxylic acid obtained by the separation was identified by means of the NMR and the mass spectrometry.

The NMR result was as follows: ¹H NMR (500 MHz, Deuterium Oxide) δ 12.39 (br, 1H, OH), 3.52 (d, J=10 Hz, 1H, CH—NH), 2.75-2.49 (m, 2H, CH₂NH), 2.05-1.98 (m, 1H, CHCH₃), 1.66-1.41 (m, 2H, CH₂CH), 1.11 (d, J=10 Hz, 3H, CHCH₃).

¹³C NMR (125 MHz, Deuterium Oxide) δ 174.56 (CHCOOH), 73.73 (CHCOOH), 43.51 (CH₂NH), 38.26 (CHCH₃), 35.93 (CH₂CH), 14.87 (CHCH₃).

The mass spectrometry showed that the molecular ion peak of the compound was 130.0802 [M+H]+ and the molecular formula thereof was determined as C₆H₁₁NO₂. The result by combining the HNMR and the CNMR confirmed that the compound was 3-methylpyrrolidine-2-carboxylic acid.

### Example 2 (2-Amino-3-Indolyl Butyric Acid and 3-Methylpyrrolidine-2-Carboxylic Acid Induce Tobacco Against Infection by Tomato Spotted Wilt Viruses)

Tomato spotted wilt viruses were taken from Yunnan province of China. An initial virus source was placed in a refrigerator at −80° C. for storage and activated by inoculation on Nicotiana benthamiana leaves by using a friction inoculation. Virus plasmids were extracted for transformation of Escherichia coli competent cells. The bacteria were coated on a resistant plate for culture, single colonies were selected for PCR screening, and positive colonies were selected for sequencing and subsequent plasmid extraction. The plasmids with normal sequencing were added into Agrobacterium competent cells and subjected to the Agrobacterium transformation by using an electric shock method. The transformed Agrobacterium liquid was coated on a screening plate with corresponding resistance and cultured at 28±1° C. for 48 h. Single colonies of the Agrobacterium on the transformation plate were selected, placed in a 5-mL LB medium containing the corresponding resistance and cultured overnight at 28° C. and 180 rpm. The bacteria were collected by centrifugation at 6,000 rpm for 2 min, suspended in an Agrobacterium treatment buffer (10 mM MgCl₂, 10 mM MES and 10 μM acetosyringone) to enable the OD₆₀₀ value of the suspension to be 0.5, and treated in a dark place at 28° C. for 3 h for later use.

2-amino-3-indolyl butyric acid was dissolved in distilled water and gradiently diluted with distilled water to obtain solutions of 0 nM, 0.1 nM, 1 nM and 10 nM. Nicotiana benthamiana seeds were sown in a small pot, illuminated at 22±1° C. for 12 h/12 h, and cultured for 5 weeks. Healthy tobacco plants (preferably 8-10 leaves) were selected and sprayed with the 2-amino-3-indolyl butyric acid solutions at the above concentrations on stems and leaves. The treatment was repeated once every 24 h and a total of two treatments was performed. After 24 h, the Agrobacterium liquid with the uniform concentration was extracted by using a 1 mL injector, an injection port of the injector was directly pressed on a small hole on the back of the tobacco leaves, and the bacterium liquid was slowly injected to infiltrate the whole leaves. The infiltrated tobacco was transferred to the environment at 22±1° C. and with 12 h/12 h illumination for culturing. The tobacco was observed and recorded by a microscope after 3 d. Meanwhile, the sample was taken, the gray levels of protein bands were analyzed by using Western blot combined with an Image J software, and the relative protein content of the viruses in the leaves was determined. The disease condition of the tobacco leaves was observed after 15 d and the disease index was recorded according to GB/T23222-2008 Grade and investigation method of tobacco diseases and insect pests. The formula was as follows:

$$Disease index = \frac{\sum [ ( Number of diseased leaves of each grade \times Relative grade value ) ] \times 100}{Total number of investigated leaves \times 9}$$

$$Relative immune effect = \frac{Disease index of blank control - Disease index of treatment}{Disease index of blank contol} \times 100 \%$$

Grading standard of diseases caused by tomato spotted wilt viruses (grading and investigation by taking plants as units):
grade 0: the whole plants were disease-free;
grade 1: the veins of interior leaves were obvious or leaves were slightly spotted, and the diseased plants were not obviously dwarfed;
grade 3: one third leaves were spotted but not deformed, or the plants were dwarfed to the heights of more than three fourths of those of normal plants;
grade 5: one third to one half leaves were spotted, or a few leaves were deformed, or main veins were blackened, or the plants were dwarfed to the heights of two thirds to three fourths of those of the normal plants;
grade 7: one half to two thirds leaves were spotted or deformed, or a few main lateral veins were necrotic, or the plants were dwarfed to the heights of one half to two thirds of those of the normal plants; and
grade 9: the leaves of the whole plates were spotted, severely deformed or necrotic, or the diseased plants were dwarfed to the heights of more than half of those of the normal plants.

TABLE 1
Effects of different concentrations of 2-amino-3-indolyl butyric
acid on infection of tobacco by tomato spotted wilt viruses

| Treatment | Disease | Relative | Content of |
|---|---|---|---|
| concentration | index | immune effect (%) | virus proteins |
| 0 | 93.21 ± 0.87a | 0 | 0.62 ± 0.012a |
| 0.1 nm | 49.70 ± 1.51b | 46.68 | 0.41 ± 0.005b |
| 1 nm | 40.91 ± 3.14c | 56.11 | 0.32 ± 0.014c |
| 10 nm | 30.42 ± 2.31d | 67.36 | 0.17 ± 0.014d |

The results in table 1 showed that when the concentration range of 2-amino-3-indolyl butyric acid was 0.1-10 nm, the infection of the tobacco by the tomato spotted wilt viruses can be significantly reduced by each treatment, the disease indexes of the tobacco infected by the tomato spotted wilt viruses were lower than 50, and the relative immune effects were 45% or more. Besides, along with the increase of the concentration in the concentration range, the disease indexes of the tobacco infected by the tomato spotted wilt viruses were significantly reduced, the relative immune effects were all significantly improved compared with that of a control, and the contents of virus proteins in the tobacco leaves were all significantly reduced. When the treatment concentration was 10 nm, the tobacco had the best immune effect on the tomato spotted wilt viruses, and the disease index, the relative immune effect and the virus content were 30.42, 67.36% and 0.17 respectively. The results showed that 2-amino-3-indolyl butyric acid can improve the immunity of the tobacco to the tomato spotted wilt viruses and effectively inhibit the tomato spotted wilt viruses from diffusing in the tobacco.

The effects of 3-methylpyrrolidine-2-carboxylic acid in inducing the tobacco against infection by the tomato spotted wilt viruses were investigated according to the same method. The results were shown in table 2.

TABLE 2
Effects of different concentrations of 3-methylpyrrolidine-2-carboxylic
acid on infection of tobacco by tomato spotted wilt viruses

| Treatment | Disease | Relative | Content of |
|---|---|---|---|
| concentration | index | immune effect (%) | virus proteins |
| 0 | 88.34 ± 1.27a | 0 | 0.61 ± 0.014a |
| 0.1 nm | 41.31 ± 0.34b | 50.84 | 0.37 ± 0.003b |
| 1 nm | 27.89 ± 2.16c | 68.43 | 0.24 ± 0.001c |
| 10 nm | 21.44 ± 1.14d | 75.73 | 0.16 ± 0.007d |

The results in table 2 showed that when the concentration range of 3-methylpyrrolidine-2-carboxylic acid was 0.1-10 nm, the infection of the tobacco by the tomato spotted wilt viruses can be significantly reduced by each treatment, the disease indexes of the tobacco infected by the tomato spotted wilt viruses were lower than 50, and the relative immune effects were 50% or more. Besides, along with the increase of the concentration in the concentration range, the disease indexes of the tobacco infected by the tomato spotted wilt viruses were significantly reduced, the relative immune effects were all significantly improved compared with that of the control, and the contents of virus proteins in the tobacco leaves were all significantly reduced. When the treatment concentration was 10 nm, the tobacco had the best immune effect on the tomato spotted wilt viruses, and the disease index, the relative immune effect and the virus content were 21.44, 75.73% and 0.16 respectively. The above results showed that 3-methylpyrrolidine-2-carboxylic acid can improve the immunity of the tobacco to the tomato spotted wilt viruses and effectively inhibit the tomato spotted wilt viruses from diffusing in the tobacco.

### Example 3 (2-amino-3-indolyl butyric acid and 3-methylpyrrolidine-2-carboxylic acid Induce Arabidopsis thaliana Against Infection by Pseudomonas syringae)

2-amino-3-indolyl butyric acid was dissolved in sterile water and gradiently diluted with sterile water to obtain solutions of 100 nm, 1,000 nm and 10,000 nm. A blank control was additionally set. Meanwhile, 0.02% Tween 20 was added as a surfactant. Pseudomonas syringae PstDC3000 was coated on an LB plate and cultured at 28° C. for 48 h; monoclonal colonies were selected, inoculated into a 50-mL centrifuge tube containing 2 mL of a culture medium, and cultured on a shaking table at 28° C. and 250 rpm, the change of an OD₆₀₀ value of the bacterial liquid was monitored every 1-2 h, and the culture of the bacteria was stopped before the OD₆₀₀ value reached 0.8; 1 mL of the bacterial liquid was transferred to a sterile 1.5-mL centrifuge tube for centrifuging at 8,000 rpm for 2 min and the precipitate was collected; the supernatant was removed, the precipitate was washed 3 times with 10 mM of magnesium chloride and centrifuged, and finally the PstDC3000 was resuspended in 10 mM of magnesium chloride enable the OD₆₀₀ value to reach 0.001 for late use. Arabidopsis thaliana seeds were soaked in 75% alcohol for 3 min, washed with sterile water for 4 times and seeded in a culture dish containing ½ MS culture medium with 12 seeds sown on each culture dish. The ½ MS culture dish carrying the seeds were vernalized at 4° C. for 3 d to break dormancy and then placed in a culture room at 22° C. and the illumination intensity of 100 μEm⁻²s⁻¹ (16 h light/8 h dark). When the seedlings grew for 2 weeks, 2-amino-3-indolyl butyric acid at different concentrations were slowly poured into the culture dish until the whole Arabidopsis thaliana seedlings were submerged for 2-3 min, then the treatment solution was completely poured from the culture dish, and the treatment was performed once every other 24 h for a total of 2 times. The PstDC3000 suspension (OD₆₀₀=0.01) was inoculated to the Arabidopsis thaliana leaves by using the same submerging method 24 h after the 2nd treatment, and then the culture dish was sealed by a medical breathable adhesive plaster after the inoculation and placed in the culture room for continuous culture. After 3 d, the number of the bacteria subjected to different treatments was determined, the disease condition of the Arabidopsis thaliana was observed, and the disease indexes were calculated by using the same calculation formula as that in example 2.

Grading standard of diseases caused by PstDC3000 (taking leaves as units):
grade 0: the leaf surfaces were free of disease spots;
grade 1: the area of the disease spots accounted for 0%-10% of that of the whole leaves;
grade 2: the area of the disease spots accounted for 10%-25% of that of the whole leaves;
grade 3: the area of the disease spots accounted for 25%-50% of that of the whole leaves;
grade 4: the area of the disease spots accounted for 50%-75% of that of the whole leaves; and
grade 5: the area of the disease spots accounted for 75%-100% of that of the whole leaves.

TABLE 3
Effects of different concentrations of 2-amino-3-indolyl butyric
acid on number of bacteria in leaves and disease indexes

| Treatment | CFU | Disease |
|---|---|---|
| concentration | (mg) | index |
| 0 | 3.20 × 10⁶ | 83.14 ± 3.40a |
| 100 nm | 7.44 × 10⁵ | 40.53 ± 1.95b |
| 1,000 nm | 6.09 × 10⁵ | 38.31 ± 1.80b |
| 10,000 nm | 4.79 × 10⁵ | 29.58 ± 1.05c |

The results in table 3 showed that the number of the bacteria in each milligram of the leaves was gradually decreased as the concentration of 2-amino-3-indolyl butyric acid was increased. When the treatment concentration was 100 nm, 1,000 nm and 10,000 nm, the number of the bacteria in each milligram of the leaves was reduced by 76.75%, 80.97% and 85.03%, and the disease indexes were reduced by 51.25%, 53.92% and 64.42% respectively. The results indicated that 2-amino-3-indolyl butyric acid can stimulate the plants to generate the immunity to the Pseudomonas syringae, inhibit the accumulation of the bacteria in the plant leaves and reduce the disease level of the plants.

The effects of 3-methylpyrrolidine-2-carboxylic acid inducing the Arabidopsis thaliana against infection by the Pseudomonas syringae were investigated according to the same method. The results were shown in table 4.

TABLE 4
Effects of different concentrations of 3-methylpyrrolidine-2-carboxylic
acid on number of bacteria in leaves and disease indexes

| Treatment | CFU | Disease |
|---|---|---|
| concentration | (mg) | index |
| 0 | 3.22 × 10⁶ | 85.17 ± 2.19a |
| 100 nm | 9.41 × 10⁵ | 50.14 ± 1.54b |
| 1,000 nm | 6.15 × 10⁵ | 40.48 ± 0.17c |
| 10,000 nm | 1.64 × 10⁵ | 23.26 ± 2.27d |

The results in Table 4 showed that the number of the bacteria in each milligram of the leaves was gradually decreased as the concentration of 3-methylpyrrolidine-2-carboxylic acid was increased. When the treatment concentration was 100 nm, 1,000 nm and 10,000 nm, the number of the bacteria in each milligram of the leaves was reduced by 70.78%, 80.90% and 94.90%, and the disease indexes were reduced by 41.13%, 52.47% and 72.69% respectively. The results indicated that 3-methylpyrrolidine-2-carboxylic acid can stimulate the plants to generate the immunity to the Pseudomonas syringae, inhibit the accumulation of the bacteria in the plant leaves and reduce the disease level of the plants.

### Example 4 (2-amino-3-indolyl butyric acid and 3-methylpyrrolidine-2-carboxylic acid Induce Wheat Against Infection by Powdery Mildew Fungi)

2-amino-3-indolyl butyric acid was dissolved in distilled water and gradiently diluted with distilled water to obtain solutions of 100 nM, 1,000 nM and 10,000 nM. A blank control was additionally set. After germination of wheat (NAU0686) seeds was accelerated, the wheat was planted in a sterilized soil culture bowl and cultured in a greenhouse at 23±1° C. with the illumination for 12 h. When the seedlings grew to a stage of one true leaf and one terminal bud, the wheat seedlings were sprayed with the 2-amino-3-indolyl butyric acid solutions at the above concentrations on stems and leaves. The treatment was repeated once every 24 h and a total of two treatments was performed. Fresh wheat powdery mildew fungus spores were evenly scattered on the wheat leaves after 24 h. 3 pots of the plants were treated each time with 20 plants in each pot. After 10 d, the disease grade of the wheat after each treatment was investigated. The disease degree was recorded according to the wheat powdery mildew grading standard in the Guidelines for Field Efficacy Trials of Pesticides (I), and the disease indexes and the relative immune effects were calculated by using the same calculation formula as that of those of the tomato spotted wilt. The results were shown in table 5.

Grading standard of wheat powdery mildew (taking leaves as units):
grade 1: the area of the disease spots accounted 5% or less of that of the whole leaves;
grade 3: the area of the disease spots accounted for 6%-15% of that of the whole leaves; and
grade 5: the area of the disease spots accounted for 16%-25% of that of the whole leaves; and
grade 7: the area of the disease spots accounted for 26%-50% of that of the whole leaves; and
grade 9: the area of the disease spots accounted for 50% or more of that of the whole leaves.

TABLE 5
Effects of different concentrations of 2-amino-3-indolyl butyric
acid on disease indexes and relative immune effects of wheat

| Treatment | | Relative |
|---|---|---|
| concentration | Disease index | immune effect (%) |
| 0 | 94.07 ± 1.05a | 0 |
| 10 nm | 73.34 ± 0.06b | 22.04 |
| 100 nm | 63.41 ± 3.78c | 32.59 |
| 1,000 nm | 43.67 ± 3.27d | 53.58 |
| 10,000 nm | 29.70 ± 2.10e | 68.43 |

The results in table 5 showed that the disease indexes of the susceptible wheat were decreased and the relative immune effects were improved as the concentration of 2-amino-3-indolyl butyric acid was increased. There were significant differences in the disease indexes for each treatment. When the concentrations were 10 nm, 100 nm, 1,000 nm and 10,000 nm respectively, the disease indexes were 73.34, 63.41, 43.67 and 29.70 respectively, and the relative immune effects were 22.04%, 32.59%, 53.58 and 68.43%. When the concentration of 2-amino-3-indolyl butyric acid was greater than 1,000 nm, the disease index of the susceptible wheat infected with the powdery mildew was lower than 50, and the relative immune effect exceeded 50% and was the best at the concentration of 10,000 nm. The results indicated that 2-amino-3-indolyl butyric acid can improve the immunity of the wheat to the fungal disease powdery mildew so as to inhibit infection and diffusion of the powdery mildew fungi in the wheat leaves, and prevent development and spread of the wheat powdery mildew.

The effects of 3-methylpyrrolidine-2-carboxylic acid inducing the wheat against infection by the powdery mildew fungi were investigated according to the same method. The results were shown in table 6.

TABLE 6
Effects of different concentrations of
3-methylpyrrolidine-2-carboxylic acid on
disease indexes and relative immune effects of wheat

| Treatment | | Relative |
|---|---|---|
| concentration | Disease index | immune effect (%) |
| 0 | 96.27 ± 1.14a | — |
| 10 nm | 72.16 ± 2.23b | 25.04 |
| 100 nm | 54.17 ± 0.97c | 43.73 |
| 1,000 nm | 40.41 ± 1.98d | 58.02 |
| 10,000 nm | 30.26 ± 1.26e | 68.57 |

The results in table 6 showed that the disease indexes of the susceptible wheat were decreased and the relative immune effects were improved as the concentration of 3-methylpyrrolidine-2-carboxylic acid was increased. There were significant differences in the disease indexes for each treatment. When the concentrations were 10 nm, 100 nm, 1,000 nm and 10,000 nm respectively, the disease indexes were 72.16, 54.17, 40.41 and 30.26 respectively, and the relative immune effects were 25.04%, 43.73%, 58.02 and 68.57%. When the concentration of 3-methylpyrrolidine-2-carboxylic acid was greater than 1,000 nm, the disease index of the susceptible wheat infected with the powdery mildew was lower than 50, and the relative immune effect exceeded 50% and was the best at the concentration of 10,000 nm. The results indicated that 3-methylpyrrolidine-2-carboxylic acid can improve the immunity of the wheat to the fungal disease powdery mildew so as to inhibit infection and diffusion of the powdery mildew fungi in the wheat leaves, and prevent development and spread of the wheat powdery mildew.

### Example 5 (Field test of 2-amino-3-indolyl butyric acid and 3-methylpyrrolidine-2-carboxylic acid Inducing Wheat Against Infection by Powdery Mildew Fungi)

Stems and leaves were sprayed with a 2-amino-3-indolyl butyric acid solution (0.02% by volume of a surfactant Tween 20 was added) at the concentration of 1,000 nm in a filed, sprayed with 0.02% by volume of the surfactant tween 20 as an auxiliary agent control and sprayed with 30 g/mu of ATaiLing as a positive control. Each treatment was repeated three times. The disease grade of the wheat after each treatment was investigated. The disease degree was recorded according to the wheat powdery mildew grading standard in the Guidelines for Field Efficacy Trials of Pesticides (I), and the disease indexes and the relative immune effects were calculated by using the same calculation formula as that of those of the tomato spotted wilt. After the harvested wheat seeds were air-dried, the thousand-grain weights of the wheat seeds after different treatments were measured.

Grading standard of wheat powdery mildew (taking leaves as units):
grade 1: the area of the disease spots accounted 5% or less of that of the whole leaves;
grade 3: the area of the disease spots accounted for 6%-15% of that of the whole leaves; and
grade 5: the area of the disease spots accounted for 16%-25% of that of the whole leaves; and
grade 7: the area of the disease spots accounted for 26%-50% of that of the whole leaves; and
grade 9: the area of the disease spots accounted for 50% or more of that of the whole leaves.

TABLE 7
Effects of 2-amino-3-indolyl butyric acid at concentration
of 1,000 nm on disease indexes, relative immune
effects and thousand-grain weights of wheat

| | | Relative immune | Thousand- |
|---|---|---|---|
| Treatment | Disease index | effect (%) | grain weight (g) |
| Auxiliary control | 76.44 ± 8.17a | 0 | 24.72 ± 0.98b |
| ATaiLing (30 g/mu) | 54.41 ± 2.82b | 28.81 | 26.75 ± 0.37ab |
| 1,000 nm | 45.44 ± 2.54c | 40.55 | 27.39 ± 0.29a |

It can be seen from the results in table 7 that the 2-amino-3-indolyl butyric acid solution at the concentration of 1,000 nm can effectively improve the immunity of the wheat to the fungal disease powdery mildew. The disease index of the wheat treated by the concentration was reduced by 40.55% and significantly lower than that of the auxiliary agent control group. Compared with the auxiliary agent control, the relative immune effect was improved by 40% and the thousand-grain weight was increased by 10.80%. Compared with an Altailing control group, the relative immune effect of the wheat was improved by 12% after sprayed with 1,000 nm of 2-amino-3-indolyl butyric acid, indicating that spraying 2-amino-3-indolyl butyric acid can effectively improve the immunity of the wheat to the fungal disease powdery mildew.

### Example 6 (2-amino-3-indolyl butyric acid and 3-methylpyrrolidine-2-carboxylic acid Induce Ryegrass Against High Temperature Stress)

2-amino-3-indolyl butyric acid was dissolved in distilled water and gradiently diluted with distilled water to obtain solutions of 1 nm, 10 nm, 100 nm and 1,000 nm. A blank control was additionally set. Meanwhile, 0.02% Tween 20 was added as a surfactant. Each concentration was set to 4 replicates while a room temperature blank control was set. Ryegrass seeds were weighed at 0.8 g per pot, sown in a pot with the diameter of 8.5 cm and planted in a greenhouse at 25° C. with the humidity of 60%-70% and the light intensity of 200 μmolm⁻²s⁻¹ (12 h light/12 h dark). After 7 d of growth, the ryegrass was treated by spraying the 2-amino-3-indolyl butyric acid solution on the leaf surfaces twice for 24 h. 24 h after the second spraying, the ryegrass was transferred to an illumination incubator at 45° C. for a high temperature stress treatment for 12 h. The plants were taken out and transferred to the greenhouse at 25° C. for recovery for 7 d. The damage conditions of the plants were observed and counted, and the heat damage grades were calculated. The heat damage grading standard was shown in table 8 and a calculation formula of the heat damage index was as follows. The heat damage results were shown in table 8.

$$Heat damage index ( \% ) = \frac{\sum Number of plants of grade \times Number of grade}{Highest grade \times Total number of treated plants} \times 100$$

TABLE 8
Heat damage grading standard

| Heat damage grade | Damage degree |
|---|---|
| 0 | The plants grew normally |
| 1 | Less than ¼ leaves showed wilting |
| 2 | ¼-½ leaves showed wilting or yellowing |
| 3 | ½-¾ leaves showed wilting or yellowing |
| 4 | ¾ leaves showed wilting or yellowing |
| 5 | The plants withered |

TABLE 9
Effects of 2-amino-3-indolyl butyric acid on
ryegrass under high temperature stress

| Treatment concentration | Heat damage index |
|---|---|
| Blank control | 0 |
| 0 | 90 |
| 1 nm | 61 |
| 10 nm | 57 |
| 100 nm | 43 |
| 1,000 nm | 25 |

The results in table 9 indicated that the heat damage indexes of the ryegrass treated with 2-amino-3-indolyl butyric acid after the high temperature stress were obviously lower than that of a control group. Besides, the heat damage indexes were gradually decreased along with the increase of the treatment concentration. When the treatment concentration increased to 1,000 nm, the heat damage index of the ryegrass decreased 65%. It can be seen that 2-amino-3-indolyl butyric acid can relieve the damage of the high temperature stress to the ryegrass plants and improve the resistance of the ryegrass to the high temperature stress.

The effects of 3-methylpyrrolidine-2-carboxylic acid inducing the ryegrass against the high temperature stress were investigated according to the same method. The results were shown in table 10.

TABLE 10
Effects of 3-methylpyrrolidine-2-carboxylic acid on
ryegrass under high temperature stress

| Treatment concentration | Heat damage index |
|---|---|
| Blank control | 0 |
| 0 | 88 |
| 1 nm | 57 |
| 10 nm | 50 |
| 100 nm | 38 |
| 1,000 nm | 20 |

The results in table 10 indicated that the heat damage indexes of the ryegrass treated with 3-methylpyrrolidine-2-carboxylic acid after the high temperature stress were obviously lower than that of the control group. Besides, the heat damage indexes were gradually decreased along with the increase of the treatment concentration. When the treatment concentration increased to 1,000 nm, the heat damage index of the ryegrass decreased 68%. It can be seen that 3-methylpyrrolidine-2-carboxylic acid can relieve the damage of the high temperature stress to the ryegrass plants and improve the resistance of the ryegrass to the high temperature stress.

### Example 7 (2-amino-3-indolyl butyric acid and 3-methylpyrrolidine-2-carboxylic acid Induce Arabidopsis thaliana Against High Temperature Stress)

Arabidopsis thaliana seeds were sown in a pot with the diameter of 8.5 cm according to about 50 seeds per pot and planted in a greenhouse at 25° C. with the humidity of 60%-70% and the light intensity of 100 μmolm⁻²s⁻¹ (16 h light/8 h dark). The treatment was started when the Arabidopsis thaliana normally grew for 21 d. Concentrations at 0 nm, 1 nm, 10 nm, 100 nm and 1,000 nm were set in the experiment. Meanwhile, 0.02% Tween 20 was added as a surfactant and four replicates were set. The spraying treatment was the same as that of the ryegrass in example 5. 24 h after the second spraying, the Arabidopsis thaliana was transferred to an illumination incubator at 45° C. for a high temperature stress treatment for 12 h. The chlorophyll fluorescences of the Arabidopsis thaliana leaf wafers were measured by using the plant efficiency Handy-PEA. The plants were taken out and transferred to the greenhouse at 25° C. for recovery for 7 d. The damage conditions of the plants were observed and counted, and the heat damage grades were calculated. The results were shown in table 11.

TABLE 11
Effects of 2-amino-3-indolyl butyric acid treatment on
Arabidopsis thaliana under high temperature stress

| Treatment concentration | PIABS | Heat damage index |
|---|---|---|
| Blank control | 25.52 ± 3.02a | 0 |
| 0 | 0.33 ± 0.25e | 75 |
| 1 nm | 0.90 ± 0.04e | 58 |
| 10 nm | 1.14 ± 0.15d | 46 |
| 100 nm | 3.28 ± 0.20c | 33 |
| 1,000 nm | 7.13 ± 0.23b | 10 |

The results in table 11 showed that under the high temperature stress, the photosynthetic performance indexes PI_{ABS} of the Arabidopsis thaliana treated by 2-amino-3-indolyl butyric acid were significantly increased and the heat damage indexes were significantly decreased. With the increase of the concentration of 2-amino-3-indolyl butyric acid, the heat damage indexes of the Arabidopsis thaliana were gradually reduced, and meanwhile, the photosynthetic performance indexes PI_{ABS} were obviously increased compared with a control group, especially, the photosynthetic performance index PI_{ABS} of the Arabidopsis thaliana at the concentration of 1,000 nm was greatly increased by 20 times compared with the control group, and the heat damage index was reduced by 65%. It can be seen that 2-amino-3-indolyl butyric acid can relieve the damage of the high temperature stress to the photosynthetic activity of the Arabidopsis thaliana and improve the resistance of the Arabidopsis thaliana to the high temperature stress.

The effects of 3-methylpyrrolidine-2-carboxylic acid inducing the Arabidopsis thaliana against the high temperature stress were investigated according to the same method. The results were shown in table 12.

TABLE 12
Effects of 3-methylpyrrolidine-2-carboxylic acid treatment
on Arabidopsis thaliana under high temperature stress

| Treatment concentration | PIABS | Heat damage index |
|---|---|---|
| Blank control | 27.33 ± 2.51a | 0 |
| 0 | 0.42 ± 0.03f | 76 |
| 1 nm | 1.87 ± 0.03e | 48 |
| 10 nm | 4.06 ± 0.17d | 37 |
| 100 nm | 6.53 ± 0.23c | 30 |
| 1,000 nm | 10.26 ± 0.46b | 8 |

The results in table 12 showed that under the high temperature stress, the photosynthetic performance indexes PI_{ABS} of the Arabidopsis thaliana treated by 3-methylpyrrolidine-2-carboxylic acid were significantly increased and the heat damage indexes were significantly decreased. With the increase of the concentration of 3-methylpyrrolidine-2-carboxylic acid, the heat damage indexes of the Arabidopsis thaliana were gradually reduced, and meanwhile, the photosynthetic performance indexes PI_{ABS} were obviously increased compared with a control group, especially, the photosynthetic performance index PI_{ABS} of the Arabidopsis thaliana at the concentration of 1,000 nm was greatly increased by 23 times compared with the control group, and the heat damage index was reduced by 68%. It can be seen that 3-methylpyrrolidine-2-carboxylic acid can relieve the damage of the high temperature stress to the photosynthetic activity of the Arabidopsis thaliana and improve the resistance of the Arabidopsis thaliana to the high temperature stress.

### Example 8 (2-amino-3-indolyl butyric acid and 3-methylpyrrolidine-2-carboxylic acid Induce Tea Tree Against Low Temperature Stress)

The test tea trees were Baiye 1 cutting seedlings.

The tea seedlings with consistent growth vigor were selected to be transplanted into a plastic pot with the diameter of 18 cm and placed in a greenhouse at 25° C. and with the humidity of 60%-70% to be adapted for growing for about one week for the experiment. Concentrations at 0 nm, 1 nm, 10 nm, 100 nm and 1,000 nm were set in the experiment. Meanwhile, 0.02% Tween 20 was added as a surfactant. The spraying treatment was the same as that of the ryegrass in example 1. A low temperature stress was performed for 24 h at −4° C. The tea seedlings after the stress was finished were taken out and subjected to a dark treatment at normal temperature for 30 min. The chlorophyll fluorescences of leaves at the tops of the tea seedlings were measured by using the plant efficiency Handy-PEA. Then the tea seedlings were placed in the greenhouse at 25° C. for recovery for 3 d. The cold damage conditions were observed, counted and graded. The cold damage index counting and grading standard was shown in table 13 and a calculation formula was as follows. The results were shown in table 14.

$$Cold damage index ( \% ) = \frac{\sum Cold damage grade \times Number of plants of corresponding cold damage}{Highest cold damage grade \times Total number of plants} \times 100$$

TABLE 13
Cold damage grading standard

| Cold | |
|---|---|
| damage | |
| grade | Damage degree |
| 0 | The plants grew normally |
| 1 | The leaf margins slightly lost water. |
| 2 | The leaf margins seriously lost water. |
| 3 | The leaf margins seriously lost water and the leaves had |
| | dehydration spots. |
| 4 | The leaf margins seriously lost water, the dehydration spots of the |
| | leaves were linked together, and a part of the leaves were shrunk. |
| 5 | The whole leaves lost water, were shrunk and withered. |

TABLE 14
Effects of 2-amino-3-indolyl butyric acid treatment
on tea leaves under low temperature stress

| Treatment concentration | PIABS | Cold damage index (%) |
|---|---|---|
| 0 | 25.82 ± 1.55d | 68 |
| 1 nm | 26.30 ± 0.04d | 52 |
| 10 nm | 30.10 ± 1.70c | 45 |
| 100 nm | 36.51 ± 3.14ab | 35 |
| 1,000 nm | 39.36 ± 2.15a | 28 |

The results in table 14 showed that the photosynthetic performance indexes PI_{ABS} of the tea leaves under the low temperature stress treated by 2-amino-3-indolyl butyric acid were significantly increased and the cold damage indexes were significantly decreased. The effect was the best when the concentration was 1,000 nm. The PI_{ABS} of the tea leaves treated under the concentration was improved by 52% and the cold damage index was reduced by 40%. It can be seen that 2-amino-3-indolyl butyric acid can relieve the damage of the low temperature stress to the photosynthetic system of the tea leaf seedlings and improve the resistance of the tea leaves on the low temperature stress.

The effects of 3-methylpyrrolidine-2-carboxylic acid inducing the tea trees against the low temperature stress were investigated according to the same method. The results were shown in table 15.

TABLE 15
Effects of 3-methylpyrrolidine-2-carboxylic acid treatment
on tea leaves under low temperature stress

| Treatment concentration | PIABS | Cold damage index (%) |
|---|---|---|
| 0 | 17.21 ± 1.06e | 75 |
| 1 nm | 23.01 ± 0.02d | 47 |
| 10 nm | 29.65 ± 1.81c | 43 |
| 100 nm | 35.01 ± 0.27b | 34 |
| 1,000 nm | 41.07 ± 0.31a | 27 |

The results in table 15 showed that the photosynthetic performance indexes PI_{ABS} of the tea leaves under the low temperature stress treated by 3-methylpyrrolidine-2-carboxylic acid were significantly increased and the cold damage indexes were significantly decreased. The effect was the best when the concentration was 1,000 nm. The PI_{ABS} of the tea leaves treated under the concentration was improved by 138% and the cold damage index was reduced by 48%. It can be seen that 3-methylpyrrolidine-2-carboxylic acid can relieve the damage of the low temperature stress to the photosynthetic system of the tea leaf seedlings and improve the resistance of the tea leaves on the low temperature stress.

### Example 9 (2-amino-3-indolyl butyric acid and 3-methylpyrrolidine-2-carboxylic acid Induce Wheat Against Drought Stress)

A 6-mesh sieve was used as a container to hydroponic wheat, 50 grains were sieved each time, a ½ Hoagland nutrient solution was replaced every other two days, a 2-amino-3-indolyl butyric acid solution was sprayed on the leaf surfaces when the wheat grew to a stage of two true leaves and one terminal bud, wherein the concentrations of 2-amino-3-indolyl butyric acid were 0 nm, 100 nm and 1,000 nm, and meanwhile, 0.02% of Tween-20 was added as a surfactant. After continuously spraying for two days, on the third day, the hydroponic nutrient solution was replaced with a ½ Hoagland nutrient solution containing 25% PEG-6000 to perform a stress treatment, a rehydration treatment was performed after the drought stress for 6 d, the wheat recovered to grow for 7 d in a normal nutrient solution, a drought damage index was observed and determined, and the root length and biomass were determined. The results were shown in table 17.

The performance characteristics of the leaves subjected to the drought damage were similar to those of the leaves subjected to a salt damage. The drought damage rate and the drought damage index were introduced by using the evaluation index of the salt damage, a drought damage index formula was as follows, and the drought damage grading standard was shown in table 16.

$$Drought damage index ( \% ) = \frac{\sum Drought damage grade \times Number of plants of corresponding drought damage}{Total number of plants \times Highest drought damage grade} \times 100$$

TABLE 16
Drought damage grading standard

| Drought | |
|---|---|
| damage | |
| grade | Damage degree |
| 0 | The leaves were free of drought damage symptoms. |
| 1 | The leaves were slightly drought-damaged, and the tips, |
| | margins or veins of a few leaves yellowed. |
| 2 | The leaves were moderately drought-damaged, |
| | and about ½ leaf tips and margins withered. |
| 3 | The leaves were severely drought-damaged, and most leaf |
| | tips and margins withered or most leaves were fallen. |

TABLE 17
Effects of 2-amino-3-indolyl butyric acid treatment on biomass
and dry damage indexes of wheat under drought stress

| | | | | | | Drought |
|---|---|---|---|---|---|---|
| | Fresh weight (g) | | Dry weight(g) | | | damage |
| Treatment | Overground | Underground | Overground | Underground | Root length | index |
| concentration | part | part | part | part | (cm) | (%) |
| 0 | 6.12 ± 0.07c | 2.91 ± 0.02c | 0.72 ± 0.03c | 0.31 ± 0.01b | 13.17 ± 0.20b | 68 |
| 100 nm | 7.28 ± 0.05b | 3.66 ± 0.01b | 0.82 ± 0.01b | 0.35 ± 0.01a | 13.97 ± 0.03a | 44 |
| 1,000 nm | 8.87 ± 0.09a | 4.51 ± 0.02a | 0.90 ± 0.05a | 0.38 ± 0.01a | 14.60 ± 0.01a | 24 |

The results in table 17 showed that the resistance of the wheat to the drought stress was gradually increased with the increase of the treatment concentration. The fresh weight, the dry weight and the root length of the wheat under the two treatment concentrations were all higher than those of a control group, such that the drought damage indexes of the wheat were obviously reduced. For example, compared with the control group, the treatment with 2-amino-3-indolyl butyric acid at the concentration of 1,000 nm significantly increased the root length of the wheat seedlings by 10.86%, improved the fresh weight of the overground part and the underground part by 44.93% and 54.98% respectively, and reduced the drought damage index by 44%. The results indicated that 2-amino-3-indolyl butyric acid can improve the drought stress resistance of the wheat.

The effects of 3-methylpyrrolidine-2-carboxylic acid inducing the wheat against the drought stress were investigated according to the same method. The results were shown in table 18.

TABLE 18
Effects of 3-methylpyrrolidine-2-carboxylic acid treatment on
biomass and dry damage indexes of wheat under drought stress

| | | | | | | Drought |
|---|---|---|---|---|---|---|
| | Fresh weight (g) | | Dry weight(g) | | | damage |
| Treatment | Overground | Underground | Overground | Underground | Root length | index |
| concentration | part | part | part | part | (cm) | (%) |
| 0 | 6.33 ± 0.09c | 3.42 ± 0.17c | 0.87 ± 0.06c | 0.40 ± 0.08c | 13.35 ± 0.32c | 81 |
| 100 nm | 7.83 ± 0.10b | 3.85 ± 0.05b | 0.98 ± 0.07b | 0.47 ± 0.05b | 14.50 ± 0.21b | 39 |
| 1,000 nm | 9.12 ± 0.13a | 4.67 ± 0.11a | 1.11 ± 0.06a | 0.55 ± 0.03a | 15.03 ± 0.31a | 20 |

The results in table 18 showed that the resistance of the wheat to the drought stress was gradually increased with the increase of the treatment concentration. The fresh weight, the dry weight and the root length of the wheat under the two treatment concentrations were all higher than those of a control group, such that the drought damage indexes of the wheat were obviously reduced. For example, compared with the control group, the treatment with 3-methylpyrrolidine-2-carboxylic acid at the concentration of 1,000 nm significantly increased the root length of the wheat seedlings by 12.58%, improved the fresh weight of the overground part and the underground part by 44.08% and 36.55% respectively, and reduced the drought damage index by 61%. The results indicated that 3-methylpyrrolidine-2-carboxylic acid can improve the drought stress resistance of the wheat.

### Example 10 (2-amino-3-indolyl butyric acid and 3-methylpyrrolidine-2-carboxylic acid Induce Cotton Against Salt Stress)

An experimental material was “Sikang 1” cotton which was hydroponic in a 500-mL plastic cup, and a ½ Hoagland nutrient solution was replaced every other two days. When the cotton seedling grew until the second true leaves were completely unfolded, a 2-amino-3-indolyl butyric acid solution was sprayed on the leaf surfaces. Concentrations at 0 nm, 1 nm, 10 nm, 100 nm and 1,000 nm were set in the experiment. Meanwhile, 0.02% Tween 20 was added as a surfactant. The solution was sprayed every 24 h for 2 times and NaCl was added into a ½ Hoagland nutrient solution the next day after the treatment to make the final concentration of 100 mM to perform a salt stress treatment. Each treatment was performed in three replicates. A rehydration treatment was performed after three days of the salt stress. The salt damage symptoms of the cotton were observed and a salt damage index was calculated by using a calculation formula as follows.

$$Salt damage index ( \% ) = \frac{\sum Diseased plants record in each grade \times Corresponding grade value}{Total number of investigated plants \times Highest salt damage grade} \times 100$$

TABLE 19
Salt damage grading standard

| Salt | |
|---|---|
| damage | |
| grade | Damage degree |
| 1 | The plant height and the number of leaves were equivalent to those of a control |
| | treatment. The plants were strong, and the leaves were open and flat, green and |
| | glossy. The plants grew normally and free of damage symptoms. |
| 2 | The plant height was 70%-100% of that of the control, the number of true leaves |
| | was 0.5-1.0 less than that of the control treatment, the cotyledons were flat, the |
| | salt damage symptoms were not obvious, and the growth was basically normal. |
| 3 | The plant height was 50%-70% of the control, the number of the true leaves was |
| | 1.0 less than that of the control, and the edges of the cotyledons curled. |
| 4 | The plant height was 50% or less of the control, no true leaves existed, only |
| | interior leaves survived, growing points were passivated, and the cotyledons |
| | were dark green and shrunk, and had curled edges. |
| 5 | The cotyledons were fallen and the plants withered and dead. |

TABLE 20
Effects of 2-amino-3-indolyl butyric acid
treatment on cotton under salt stress

| Treatment concentration | Salt damage index (%) | Mortality (%) |
|---|---|---|
| 0 | 76 | 69 |
| 1 nm | 63 | 45 |
| 10 nm | 57 | 43 |
| 100 nm | 53 | 33 |
| 1,000 nm | 44 | 27 |

The results in table 20 showed that the salt damage indexes of the cotton decreased with the increase of the concentration of 2-amino-3-indolyl butyric acid, and the mortality of each treated plant was lower than that of the control. At the concentration of 1,000 nm, the salt damage index and the mortality were the lowest, 44% and 27%, respectively. The results showed that 2-amino-3-indolyl butyric acid can induce the cotton to have a better resistance to the salt stress. The effects of 3-methylpyrrolidine-2-carboxylic acid inducing the cotton against the salt stress were investigated according to the same method. The results were shown in table 21.

TABLE 21
Effects of 3-methylpyrrolidine-2-carboxylic acid
treatment on cotton under salt stress

| Treatment concentration | Salt damage index (%) | Mortality (%) |
|---|---|---|
| 0 | 83 | 75 |
| 1 nm | 67 | 47 |
| 10 nm | 54 | 42 |
| 100 nm | 49 | 28 |
| 1,000 nm | 39 | 24 |

The results in table 21 showed that the salt damage indexes of the cotton decreased with the increase of the concentration of 3-methylpyrrolidine-2-carboxylic acid, and the mortality of each treated plant was lower than that of the control. At the concentration of 1,000 nm, the salt damage index and the mortality were the lowest, 39% and 24%, respectively. The results showed that 3-methylpyrrolidine-2-carboxylic acid can induce the cotton to have a better resistance to the salt stress.

Chemically synthesized 2-amino-3-indolyl butyric acid and 3-methylpyrrolidine-2-carboxylic acid also had the same effect as biologically extracted 2-amino-3-indolyl butyric acid and 3-methylpyrrolidine-2-carboxylic acid. The preparation methods and the sources of 2-amino-3-hydroxy-3-methylbutyric acid and 3-methylpyrrolidine-2-carboxylic acid did not influence the use and the effects of the compounds as a plant immunity elicitor.

1. A method for preparing a plant immunity elicitor comprising preparing a composition comprising 2-amino-3-indolyl butyric acid and/or 3-methylpyrrolidine-2-carboxylic acid.

2. A method for improving resistance of a plant to an abiotic stress and/or a biotic stress comprising treating the plant with 2-amino-3-indolyl butyric acid and/or 3-methylpyrrolidine-2-carboxylic acid, wherein the abiotic stress is any one or more selected from high temperature, low temperature, drought and/or salt stresses, the biotic stress is any one or more selected from fungal, bacterial and viral stresses, a fungal disease is wheat powdery mildew, a bacterial disease is a disease caused by Pseudomonas syringae and a viral disease is tomato spotted wilt.

3. The method according to claim 1, wherein the plant is selected from a grain crop, an economic crop and a vegetable.

4. The method according to claim 3, wherein the grain crop is wheat, the economic crop is ryegrass, tea leaves and cotton, and the vegetable is tomatoes.

5. A plant immunity elicitor containing a component A: any one or two of 2-amino-3-indolyl butyric acid or 3-methylpyrrolidine-2-carboxylic acid, and a component B: a surfactant.

6. The plant immunity elicitor according to claim 5, wherein the surfactant is Tween 20.

7. The plant immunity elicitor according to claim 6, wherein the concentration of the Tween 20 in the plant immunity elicitor is 0.01-0.05% (v/v), preferably 0.02% (v/v).

8. The plant immunity elicitor according to claim 5, wherein the concentration of 2-amino-3-indolyl butyric acid or 3-methylpyrrolidine-2-carboxylic acid in the plant immunity elicitor is 0.1-10,000 nm.

9. A method for improving resistance of a plant to a biotic and/or an abiotic stress, wherein 0.1-10,000 nm of 2-amino-3-indolyl butyric acid or 3-methylpyrrolidine-2-carboxylic acid is applied to a target plant.

10. The method according to claim 9, wherein the abiotic stress is any one or more selected from high temperature, low temperature, drought and/or salt stresses, the biotic stress is any one or more selected from fungal, bacterial and viral stresses, a fungal disease is wheat powdery mildew, a bacterial disease is a disease caused by Pseudomonas syringae and a viral disease is tomato spotted wilt.

11. The method according to claim 2, wherein the plant is selected from the grain crop, the economic crop and the vegetable.
